(19) United States
(12) Patent Application Publication
(10) Pub. No.: US 2026/0342951 A1
(43) Pub. Date: Oct. 29, 2026

(54) SPATIAL VIDEO GENERATION VIA IMAGE DATA CAPTURED BY EXTENDED REALITY SYSTEMS

(71) Applicant: Meta Platforms Technologies, LLC, Menlo Park, CA (US)

(72) Inventors: Zuoqian WANG, Santa Clara, CA (US); Shizhe SHEN, Los Altos, CA (US); Serge BIERHUIZEN, Cupertino, CA (US); Min TAO, Palo Alto, CA (US); Alexander Randon COPE, Portland, OR (US)

(21) Appl. No.: 19/631,080

(22) Filed: Mar. 27, 2026

Related U.S. Application Data
(60) Provisional application No. 63/794,031, filed on Apr. 24, 2025.

(51) Int. Cl. H04N 13/156; G06T 7/33; G06T 7/70; H04N 13/194; H04N 13/243; H04N 13/282; H04N 13/344; H04N 13/00

(52) U.S. Cl. CPC H04N 13/156; G06T 7/337; G06T 7/70; H04N 13/194; H04N 13/243; H04N 13/282; H04N 13/344; G06T 2207/10021; G06T 2207/30244; H04N 2013/0081

(57) ABSTRACT

Aspects of the present disclosure are directed to generating and providing three-dimensional spatial videos of a real-world environment by extended reality (XR) systems, such as augmented reality (AR) systems (e.g., smart glasses). For example, a spatial video generation system can provide 3D spatial video capturing capabilities to XR systems that can allow virtual reality (VR) and mixed reality (MR) systems to have immersive video replay in which users can have the experience of moving through and interacting with the captured real-world environment. The XR system can be equipped with multiple cameras and depth sensors for 3D spatial video capturing. In some implementations, additional cameras can be provided on other wearable devices in communication with the XR system, such as a hat.

### CROSS-REFERENCE TO RELATED APPLICATIONS

This application claims priority to U.S. Patent Application No. 63/794,031, filed on Apr. 24, 2025, titled “Spatial Video Generation by Augmented Reality Systems,” which is herein incorporated by reference in its entirety.

### TECHNICAL FIELD

The present disclosure is directed to generating three-dimensional (3D) spatial videos based on image data and/or depth data captured by extended reality (XR) systems, such as augmented reality (AR) glasses.

### BACKGROUND

Extended reality (XR) devices are becoming more prevalent. As they become more popular, the applications and user interfaces implemented on such devices are becoming more sophisticated. Mixed reality (MR) and augmented reality (AR) applications can provide interactive three-dimensional (3D) experiences that combine images of the real-world with virtual objects (e.g., user interfaces), while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. In some cases, an HMD can have a pass-through display, which allows light from the real-world to pass through a lens to combine with light from a waveguide that simultaneously emits light from a projector in the HMD or can include a passthrough system where images captured of the real world are combined with digital content, allowing the HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an extended reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for generating three-dimensional (3D) spatial video for an extended reality (XR) playback system.

FIG. 6 is a conceptual diagram illustrating augmented reality (AR) glasses which can be used in some implementations of the present technology.

FIGS. 7A-7B are conceptual diagrams illustrating an example of an AR system capturing multiple images and merging them to form 3D spatial video.

FIGS. 8A-8B are conceptual diagrams illustrating example views, on an XR playback system, of an immersive replay of a 3D spatial video capturing a real-world environment.

The techniques introduced here may be better understood by referring to the following Detailed Description in conjunction with the accompanying drawings, in which like reference numerals indicate identical or functionally similar elements.

### DETAILED DESCRIPTION

Extended reality (XR) systems provide users with immersive digital experiences by combining images of the real world with virtual objects and/or by creating entirely self-contained computer-generated environments. Users typically experience these environments through head-mounted displays (HMDs), such as headsets or smart glasses, which can present virtual content overlaid on or in place of the user's view of the real world. Current smart glasses offer a convenient, first-person perspective for capturing moments from a user's life. However, these devices are conventionally equipped with only a single camera. As a result, they are limited to capturing standard two-dimensional (2D) video. While this 2D video can be shared or live-streamed, it fails to capture the spatial depth of the environment, preventing the creation of a truly immersive, three-dimensional (3D) experience that can be replayed on a VR or MR system.

Some mobile computing devices, such as smartphones, have begun to incorporate spatial video capture capabilities by using two adjacent cameras. While these systems can generate a form of 3D video, their effectiveness is limited by the physical constraints of the device. The cameras are necessarily positioned very close to one another, providing a narrow stereoscopic baseline. This makes it difficult to capture high-quality depth information across a wide field of view, resulting in spatial video that lacks the depth and realism required for a truly immersive replay experience.

Furthermore, the ecosystems for capturing personal video and consuming immersive content are often disconnected. Transferring content from a capture device like a smartphone to a consumption device like a VR headset can be cumbersome, and there fail to be systems that provide for the seamless, real-time streaming of a captured 3D environment from one user to another. Therefore, there is a need in the art for an improved system and method for generating high-quality, immersive 3D spatial video from a convenient, wearable form factor, and for a more integrated ecosystem that connects the capture of real-world experiences with their immersive consumption.

Aspects of the present disclosure meet these needs and others by generating and providing 3D spatial videos of a real-world environment amongst extended reality (XR) systems, such as augmented reality (AR) systems, smart glasses, virtual reality (VR) systems, mixed reality (MR) systems, etc. For example, a spatial video generation system can provide 3D spatial video capturing capabilities to AR systems that can allow VR and/or MR systems to have immersive video replay in which users can have the experience of moving through and interacting with the captured real-world environment. The AR system can be equipped with multiple cameras and depth sensors for 3D spatial video capturing. In some cases, additional cameras can be provided on other wearable devices in communication with the AR system, such as a hat. In some implementations, the spatial video generation system can allow users to capture, view, store, and/or interact with the 3D spatial video in real-time (such as in a livestream) or at any future time, providing an XR experience closely resembling human eye vision and human field of view. The spatial video generation system can be applicable to one or multiple of various implementations, such as gaming, education, training, entertainment, etc. Further, the spatial video generation system can enable 3D memory generation, storage, and replaying.

The implementations described herein directly address the problems and limitations inherent in conventional systems by creating an integrated, end-to-end ecosystem for the capture and playback of immersive, 3D spatial video. For example, the spatial video generation system described herein overcomes the limitation of single-camera wearable devices. While conventional smart glasses are typically restricted to capturing standard two-dimensional (2D) video, which fails to create an immersive, replayable experience, the disclosed system incorporates a plurality of cameras disposed at spatially disparate locations. By capturing multiple, contemporaneous images from different perspectives, the system obtains the necessary multi-view data needed for generating a true 3D representation of a real-world environment, thereby moving far beyond the 2D capabilities of conventional wearable cameras.

In addition, the system specifically solves the problem of poor spatial capture quality found in compact devices like smartphones. As noted above, while such devices may have multiple cameras, their close physical proximity results in a narrow stereoscopic baseline, limiting the quality of the captured depth information. Some implementations described herein overcome this by distributing the cameras across the wider frame of a wearable device, such as on opposite sides of a pair of smart glasses. This creates a wider and more effective stereoscopic baseline that more closely mimics human inter-pupillary distance. This wider baseline enables the capture of more accurate depth data and a more pronounced parallax effect, resulting in a higher-fidelity and more realistic 3D spatial video than what is achievable with conventional mobile devices.

Further, some implementations of the system described herein address the problem of disconnected capture and consumption ecosystems. For example, the system can provide an integrated ecosystem that includes a dedicated processing pipeline and communication protocol. This enables the system to not only generate the 3D spatial video, but also to transmit it in real-time or near real-time to a separate playback system, such as a virtual reality (VR) and/or mixed reality (MR) headset. This seamless integration enables novel shared experiences, such as live immersive 3D streaming from one user to another, directly solving the problem of disconnected and non-real-time workflows.

As a conceptual example of how the spatial video generation system can operate, a user can don an augmented reality (AR) system. The AR system can be equipped with multiple cameras and depth sensors positioned at various, spatially distributed locations on the body of the XR system. For example, cameras may be located near each of the user’s temples, on the bridge of the AR system, and on the side portions of the body. The user decides to go for a walk in a park and wants to share the experience in real-time with their friend, who is in another location.

The user initiates a spatial video capture session using a control on their AR system. The multiple cameras on the AR system then begin capturing multiple, contemporaneous video streams of the park environment from their distinct perspectives. Simultaneously, the depth sensors capture depth data, measuring the distance to various objects in the scene, such as trees, a pathway, and other people.

The AR system begins processing this incoming data in real-time or near real-time (e.g., within 300 ms). The AR system executes instructions to augment the multiple video streams with the corresponding depth data. It then identifies overlapping regions and common features within the different video streams to understand how they relate to one another spatially. Using this information, the AR system stitches the augmented video streams together, generating a single, cohesive, 3D spatial video of the park from the user’s point of view.

As the 3D spatial video is being generated, a communication interface on the AR system transmits the video data wirelessly over a network to their friend. The friend is wearing a virtual reality (VR) headset, which receives the live stream. When the friend looks into their headset, they do not see a flat, 2D video. Instead, they are presented with an immersive, three-dimensional view of the park as if they were standing in the user’s shoes. The friend can perceive the depth of the trees along the path and the distance to a fountain in the background. As the friend moves their head, their perspective shifts slightly, providing a natural sense of parallax and reinforcing the feeling of being physically present in the captured environment.

After the walk, the user ends the capture session. In addition to the live stream, the AR system provides the user with the option to save the entire session. The user chooses to store the generated 3D spatial video to data storage. At a later date, the user can access this saved file and, using their own mixed reality (MR) headset, re-experience their walk in the park as an immersive 3D memory, allowing the user to look around and revisit the moment with a true sense of depth and presence.

As used herein, the phrase “3D spatial video” and/or “spatial video” refers to a video format that captures and represents a real-world environment in three dimensions. Unlike a conventional two-dimensional (2D) video, which records a flat image from a single perspective, a spatial video can include depth data associated with the captured scene. This depth and dimensional information can be generated by capturing a scene from multiple, spatially distinct perspectives, for example, by using a plurality of cameras, and can be augmented by data from one or more depth sensors in some implementations. The resulting video data, when rendered on a suitable playback device such as a virtual reality (VR) and/or mixed reality (MR) headset, creates an immersive experience that allows a viewer to perceive depth, parallax, and a sense of presence within the recorded environment.

In some implementations, the 3D spatial video can provide a single viewpoint into a real-world environment. In some implementations, the 3D spatial video can provide full or partial rotational movement within the real-world environment (e.g., allowing the user to look up, down, left, and/or right), provide full or partial translational movement within the real-world environment (e.g., physically move their head a short distance, such as leaning forward, backward, side-to-side, and/or up and down), and/or provide full six degrees of freedom (6DoF). In some implementations, the number of viewpoints provided by the 3D spatial video can be dependent on one or more of the number of images captured of the real-world environment, the number of cameras capturing images, how much of the real-world environment is captured, how many perspectives are captured, etc., as appreciated by one skilled in the art.

Embodiments of the disclosed technology may include or be implemented in conjunction with an extended reality system. Extended reality, artificial reality, or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Extended reality content may include completely generated content or generated content combined with captured content (e.g., real-world photographs). The extended reality content may include video, audio, haptic feedback, or some combination thereof, any of which may be presented in a single channel or in multiple channels (such as stereo video that produces a three-dimensional effect to the viewer). Additionally, in some embodiments, extended reality may be associated with applications, products, accessories, services, or some combination thereof, that are, e.g., used to create content in an extended reality and/or used in (e.g., perform activities in) an extended reality. The extended reality system that provides the extended reality content may be implemented on various platforms, including a head-mounted display (HMD) connected to a host computer system, a standalone HMD, a mobile device or computing system, a "cave" environment or other projection system, or any other hardware platform capable of providing extended reality content to one or more viewers.

"Virtual reality" or "VR," as used herein, refers to an immersive experience where a user's visual input is controlled by a computing system. "Augmented reality" or "AR" refers to systems where a user views images of the real world after they have passed through a computing system. For example, a tablet with a camera on the back can capture images of the real world and then display the images on the screen on the opposite side of the tablet from the camera. The tablet can process and adjust or "augment" the images as they pass through the system, such as by adding virtual objects. "Mixed reality" or "MR" refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Extended reality,” "Artificial reality," "extra reality," or "XR," as used herein, refers to any of VR, AR, MR, or any combination or hybrid thereof.

In addition to the specific improvements provided above, the present technology further improves the functioning of the underlying computing systems involved. For example, in some implementations, by performing on-device or local processing to augment image data and stitch it into a single, coherent 3D spatial video stream, the system improves upon methods that would require transmitting multiple raw, uncompressed video feeds to a remote server. Generating the spatial video locally before transmission reduces the overall bandwidth required for streaming and enables lower-latency, real-time playback.

In some implementations, the system architecture is flexible, allowing for processing to be offloaded from a wearable capture device (e.g., smart glasses) to a more powerful external processing component (e.g., a smartphone, a dedicated external processing component, a remote server, etc.). This split-compute model allows the wearable device to be designed with a focus on lower power consumption, reduced thermal output, and a lighter weight, as the computationally intensive tasks of video stitching and 3D model generation are handled by a system with greater resources. This can directly improve the functioning of the wearable component by extending its battery life and enhancing user comfort.

In some implementations, the system can transform the function of a standard computing processor into a specialized spatial video generation engine. By executing instructions to obtain data from multiple, disparate sensor sources (e.g., cameras and depth sensors), generate a localization model to determine their relative poses, and fuse this data into a single, immersive 3D video, the XR system performs a new and specific function not possible with conventional video capture methods. This improved processing directly results in a higher-quality output for the end user, providing a more realistic and immersive display experience on a playback system than what could be achieved with video from conventional single-camera or narrow-baseline systems.

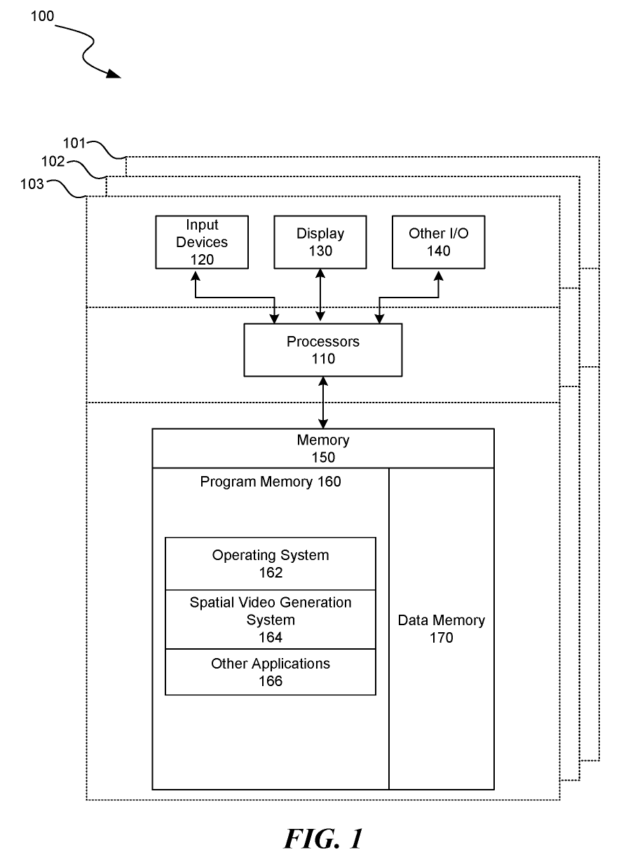

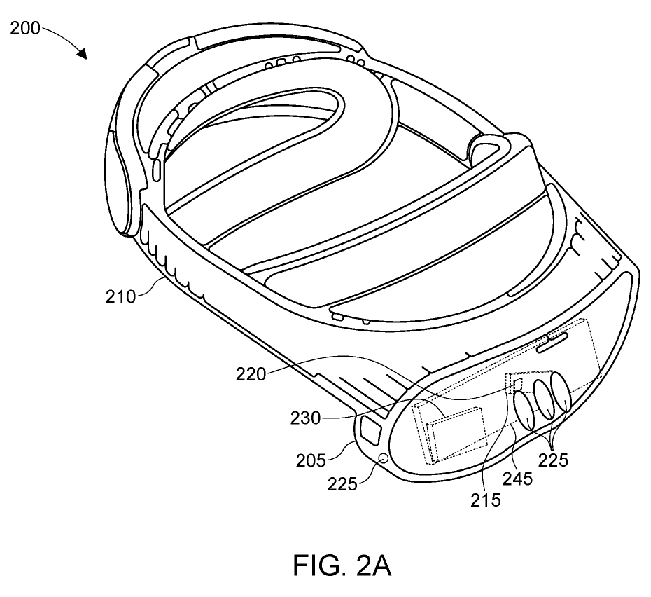

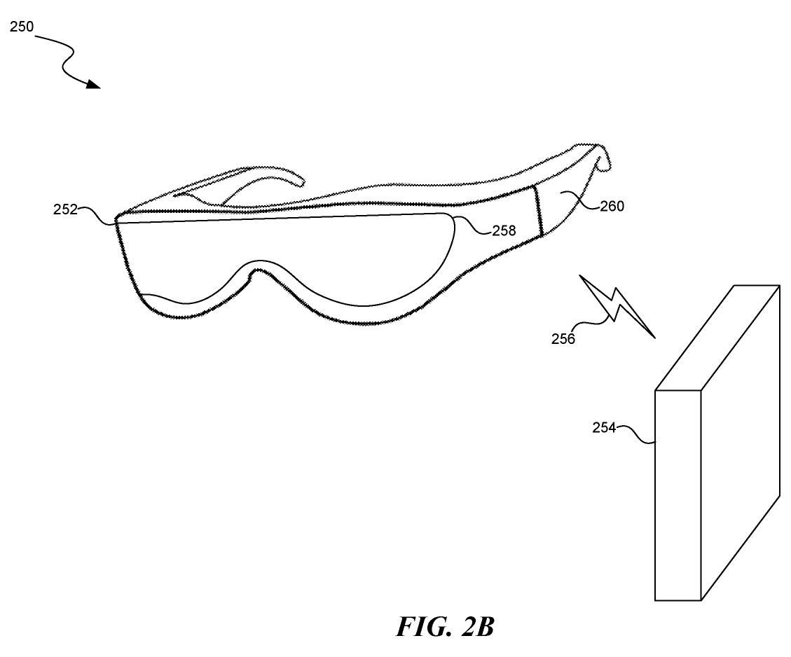

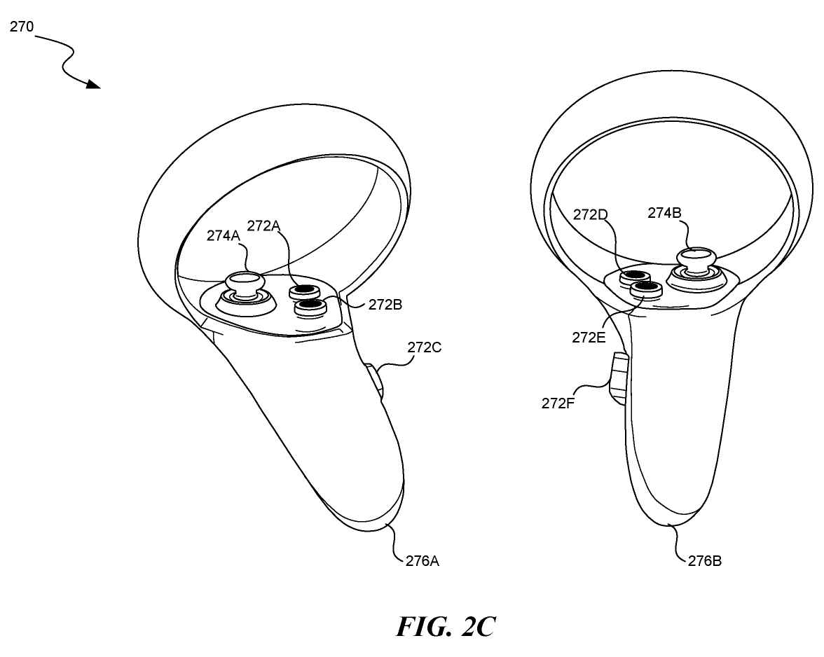

Several implementations are discussed below in more detail in reference to the figures. FIG. 1 is a block diagram illustrating an overview of devices on which some implementations of the disclosed technology can operate. The devices can comprise hardware components of a computing system 100 that can generate three-dimensional (3D) spatial video for an extended reality (XR) playback system. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, spatial video generation system 164, and other application programs 166. Memory 150 can also include data memory 170 that can include, e.g., image data, camera data, camera location data, depth data, sensor data, augmentation data, spatial video data, stitching data, localization data, audio data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to perform steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an extended reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200. In some implementations, cameras 225 can also capture images of parts of the user, such as hands, feet, or other body parts, and use these images to track the position of these body parts. In some cases, this hand / body tracking can be performed in addition or alternatively by worn devices, such as a wrist band, ring, glove, etc. Addition details on user tracking are provided below in relation to FIG. 2C.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects. In some implementations, the cameras can capture images of parts of the user, such as hands, feet, or other body parts, and use these images to track the position of these body parts. In some cases, this hand / body tracking can be performed in addition or alternatively by worn devices, such as a wrist band, ring, glove, etc. Addition details on user tracking are provided below in relation to FIG. 2C.

FIG. 2C illustrates controllers 270 (including controller 276A and 276B), which, in some implementations, a user can hold in one or both hands to interact with an extended reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction. In some implementations, images captured of the of the user’s hands can be used to determine a pose and/or position of the hands, which can then be translated to user input and/or to control position or pose of an avatar representing the user in an extended reality environment. For example, various machine learning systems (e.g., trained using synthetic hand pose/position and location information or trained using hand images paired with pose and position data from other tracking devices such as external cameras or tracking sensors) can receive image representations and translate them into hand pose and/or position information. In some implementations, one or more other controllers shapes and configurations can also be used, such as a wrist worn band that translates electrical signals projected into the user’s wrist and then read to interpret a hand pose. For example, such electrical signals can be interpreted by a machine learning system that has been trained using such read electrical signals paired with poses determined by a worn glove or other pose data. In some implementations, such a band can also include various tracking systems, such as an IMU unit, cameras for inside-out tracking, etc.

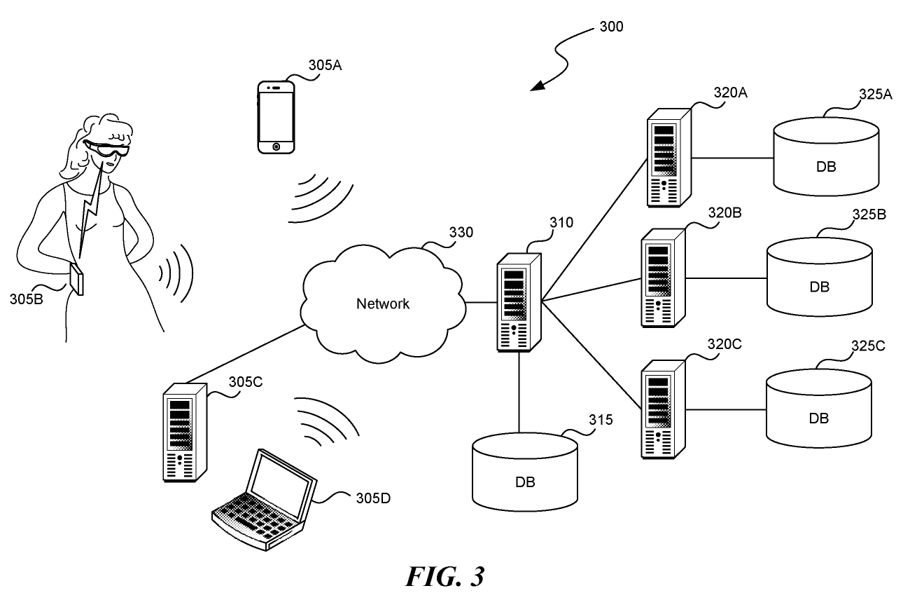

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

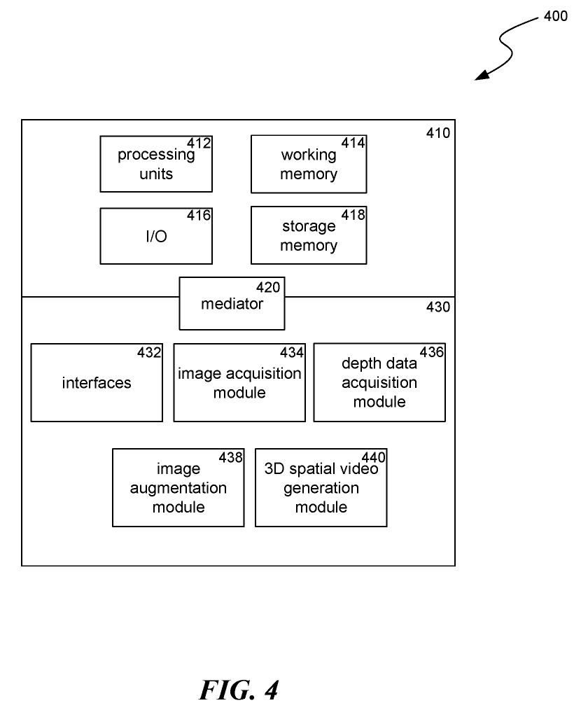

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for generating three-dimensional (3D) spatial video for an extended reality (XR) playback system. Specialized components 430 can include image acquisition module 434, depth data acquisition module 436, image augmentation module 438, 3D spatial video generation module 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

Image acquisition module 434 can obtain multiple images of a real-world environment, which can include still images and/or video of the real-world environment. In some implementations, the multiple images can be contemporaneously captured from multiple perspectives (e.g., multiple positions and/or orientations) by multiple cameras disposed at spatially disparate locations on an XR system. In some implementations, the XR system can be and/or include an augmented reality (AR) system, such as smart glasses. The multiple cameras can capture at least partially different portions of the real-world environment. For example, the cameras can be included on the front of the XR system, on the back of the XR system, on the sides of the XR system, etc., instead of having only one camera, such as in traditional smart glasses.

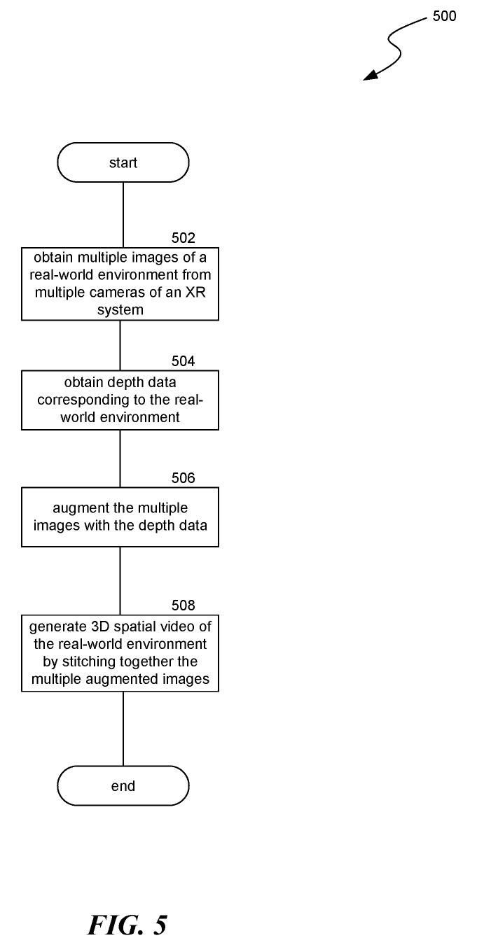

In some implementations, image acquisition module 434 can obtain one or more images from a separate image capture device and/or computing device including a camera, such as a smartphone, a tablet, a wearable device, etc., worn and/or carried by the user of the XR system. In some implementations, image acquisition module 434 can obtain image(s) from camera(s) included in other systems or devices, such as other XR systems, mobile devices, wearable devices, etc., worn or carried by or one or more other users. For example, image acquisition module 434 can obtain image(s) from camera(s) in mixed reality (MR) or virtual reality (VR) head-mounted displays (HMDs), smart jewelry, hats, smartphones, tablets, etc. As compared to smartphones and other devices which have only a limited number of cameras (e.g., two) that are spaced close together, the XR system (and/or any additional systems and/or devices including one or more cameras) can provide more cameras that are more spatially distanced from each other and can capture images from many different angles, thereby providing better images for spatial video in some cases. In some implementations, image acquisition module 434 can additionally obtain image(s) of the real-world environment from one or more stationary cameras placed in the real-world environment. In some implementations, image acquisition module 434 can obtain one or more images based on an upload from a user computing device storing the image(s), and/or from a local or remote database storing the image(s). Further details regarding obtaining multiple images of a real-world environment are described herein with respect to block 502 of FIG. 5.

Depth data acquisition module 436 can obtain depth data corresponding to the real-world environment. In some implementations, the depth data can be captured by one or more depth sensors positioned on and/or within the XR system. In some implementations, the one or more depth sensors can be collocated with one or more cameras and/or have the same position and orientation (thus having the same perspective) as one or more cameras. Thus, depth data acquisition module 436 can ascertain the depth of objects in the real-world environment captured in the images by the cameras. Further details regarding obtaining depth data corresponding to a real-world environment are described herein with respect to block 504 of FIG. 5.

Image augmentation module 438 can augment the multiple images, obtained by image acquisition module 434, with the depth data obtained by depth data acquisition module 436, thereby fusing the two-dimensional (2D) image data with the 3D geometric data. Thus, image augmentation module 438 can transform the set of flat, independent images into a rich, volumetric data structure, such as RGB-D images. In some implementations, to perform this augmentation, image augmentation module 438 can utilize a known geometric relationship between the cameras and depth sensors, which provides the transformation needed to project the captured depth data onto the corresponding image planes. For example, image augmentation module 438 can correlate each or one or more pixels’ (and/or sets of pixels’) color and intensity information (e.g., RGB values) with a corresponding depth value (a “Z” coordinate). The result is that each pixel (and/or set of pixels) in the augmented images is associated with a specific point in 3D space, providing a volumetric understanding of the scene from multiple perspectives. Further details regarding augmenting multiple images with obtained depth data are described herein with respect to block 506 of FIG. 5.

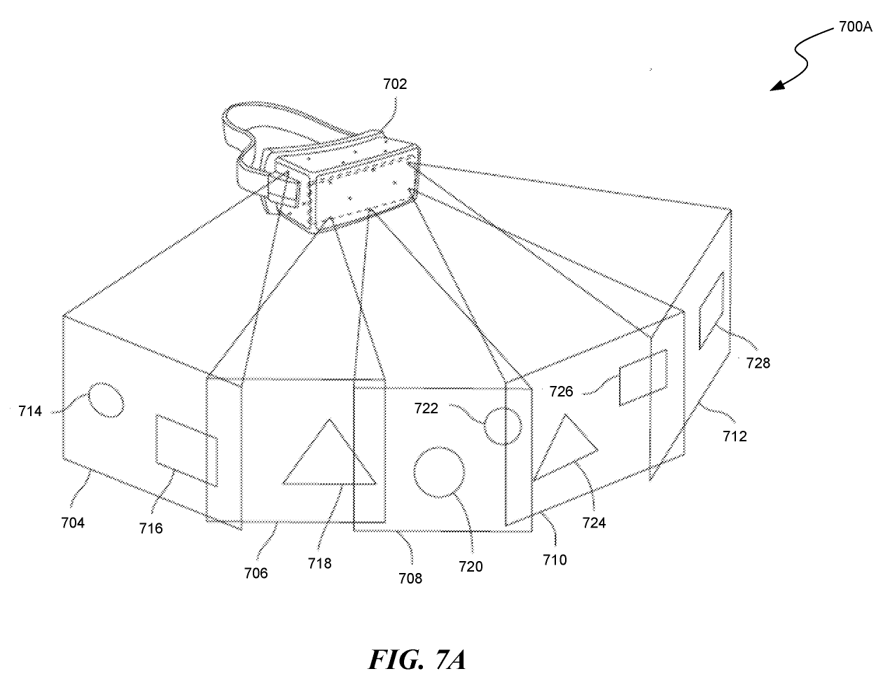

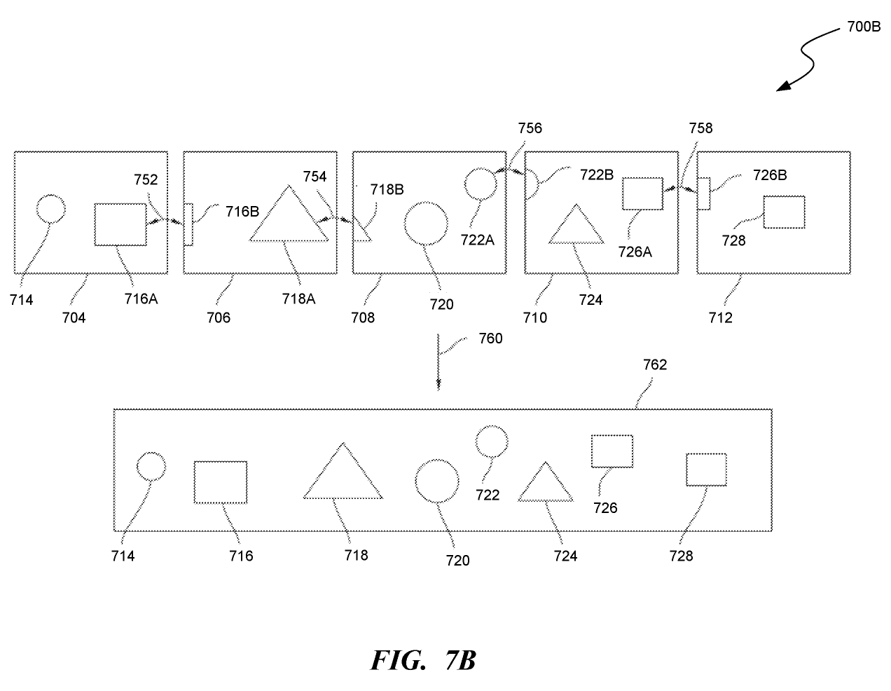

3D spatial video generation module 440 can generate a 3D spatial video of the real-world environment by stitching together the multiple augmented images generated by image augmentation module 438. In some implementations, 3D spatial video generation module 440 can stitch the images together into a single image (e.g., for each frame and at each point in time) by matching features between the images to determine overlap and combining the images at the determined overlaps, such as described further herein with respect to FIGS. 7A-7B. In some implementations, using the image and depth data, 3D spatial video generation module 440 can generate a Simultaneous Localization and Mapping (SLAM) map or other 3D model of its surrounding real-world environment. In some implementations, 3D spatial video generation module 440 can adjust the images to be from the perspective of the user of the XR system, based on determined distances between the user’s eyes and the cameras that captured the images.

In some implementations, 3D spatial video generation module 440 can generate the 3D spatial video of the real-world environment in real-time or near real-time, as images and depth data for the real-world environment are obtained (e.g., within 1 second). In some implementations, 3D spatial video generation module 440 can further store the 3D spatial video. In some implementations,3D spatial video generation module 440 can transmit the 3D spatial video to one or more other systems, such as one or more of other XR systems, remote computing systems (e.g., central servers), etc., via a video transfer interface. In some implementations, the 3D spatial video can be immersively replayed on XR systems, such as VR systems and/or MR systems. Further details regarding generating a 3D spatial video of a real-world environment by stitching together multiple images are described herein with respect to block 508 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for generating three-dimensional (3D) spatial video for an extended reality (XR) playback system. In some implementations, one or more blocks of process 500 can be performed by an XR system, which can be the same or different XR system and/or type of XR system than the XR playback system displaying the spatial video. In some implementations, the XR system and/or the XR playback system can be a virtual reality (VR) system and/or mixed reality (MR) system. In some implementations, the XR system can be an augmented reality (AR) system, which, in some implementations, can include AR glasses, such as smart glasses comprising a pair of at least partially or fully see-through (e.g., transparent) lenses. The XR system and/or XR playback system can include any number or one or more XR devices, such as one or more XR head-mounted displays (HMDs), one or more controllers, one or more external processing components, etc.

In some implementations, one or more blocks of process 500 can be performed by a computing system remote from the XR system and/or the XR playback system, such as a computing system associated with a platform of the XR system and/or XR playback system. In some implementations, the computing system can include one or more cloud computing systems and/or edge computing systems. In some implementations, process 500 can be performed based on a user-, application-, or system-level request to capture data used for generation of spatial video, which can include image data (e.g., still images and/or video images), depth data, audio data, or any combination thereof. In some implementations, process 500 can be performed upon powering on, activation, and/or donning of the XR system.

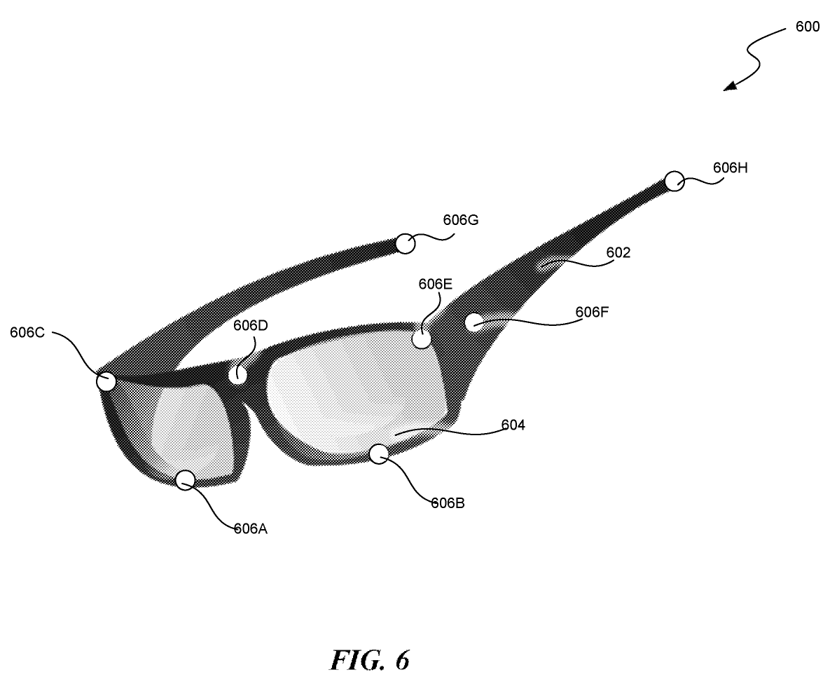

At block 502, process 500 can obtain multiple images of a real-world environment surrounding an XR system. The images can be captured as a set of still photographs and/or as continuous video streams from one or more cameras. In some implementations, the multiple images can be captured by multiple cameras. In some implementations, at least some of the multiple images are captured from multiple perspectives by multiple cameras disposed at spatially disparate locations on (e.g., integral with) the XR system, such as spaced apart on the frame of a pair of smart glasses (e.g., an exemplary AR system). For example, one or more cameras can be positioned on opposite sides of the frame (e.g., near the user's temples) to establish a wide stereoscopic baseline, which can be used by the XR system for capturing high-quality depth information. In some implementations, one or more cameras can be located on the front, sides, and/or rear-facing portions of the frame to capture a wider, potentially 360-degree, field of view. An exemplary AR system including multiple spatially disparate cameras is shown and described further herein with respect to FIG. 6.

In some implementations, at least some of the multiple images can be captured contemporaneously, e.g., at the same instant in time or within a very narrow, synchronized time window (e.g., within 10 ms). In some cases, this synchronized capture can ensure that any motion in the real-world environment is frozen consistently across all viewpoints, which can prevent temporal artifacts, such as tearing or ghosting, when the images are later stitched together into a cohesive 3D representation, as described further herein.

In some implementations, process 500 can obtain one or more additional images of the real-world environment from one or more additional cameras external to the XR system (e.g., not integral with the XR system). In some implementations, the one or more additional cameras can be integral with one or more wearable accessories in networked communication with the XR system. The wearable accessories can include one or more of, for example, a camera-enabled hat, a camera-enabled headband or hairpiece, camera-enabled jewelry (e.g., a necklace), a camera-enabled scarf or neckband, camera-enabled shoes, a camera-enable watch, and/or the like. In some implementations, the one or more additional cameras can be included in one or more mobile devices, such as one or more of a smartphone, a tablet, a laptop computer, etc. In some implementations, process 500 can incorporate the one or more additional images into the generated 3D spatial video. In some implementations, incorporating such additional images can further expand the field of view to provide additional perspectives for the 3D reconstruction, as described further herein.

In some implementations, process 500 can further obtain audio data corresponding to the real-world environment. For example, in conjunction with the image capture, one or more microphones integrated into the XR system can contemporaneously capture the audio data from the real-world environment. In some implementations, depending on the number and placement of the microphones, this audio data can be mono, stereo, or immersive spatial audio that corresponds to the visual scene being recorded. In some implementations, one or more of such microphones can be external to the XR system (e.g., not integral with the XR system), such as can be included in one or more wearable accessories, in one or more mobile devices (e.g., a smartphone, a tablet, etc.), and/or the like.

At block 504, process 500 can obtain depth data corresponding to the real-world environment. In some implementations, the XR system can capture the depth data via one or more depth sensors positioned on (e.g., integral with) the XR system. In some implementations, this depth data can provide 3D depth information, effectively creating a geometric map of the scene by defining the distance of various objects and surfaces in the real-world environment from the XR system. In some implementations, the one or more depth sensors can be positioned and/or oriented on the XR system with a known relationship to the position(s) and/or orientation(s) of one or more of the multiple cameras and/or with known geometric position(s) and/or orientation(s) relative to each other.

In some implementations, a depth sensor can be co-located with a camera, forming an integrated sensor module. For example, a forward-facing camera on the frame of a pair of smart glasses can be paired with an adjacent Time-of-Flight (ToF) or structured light sensor. In such a configuration, the optical axis of the depth sensor can be oriented to be substantially parallel to the optical axis of the paired camera, ensuring their respective fields of view have significant overlap. This co-located arrangement can minimize parallax between the sensors, simplifying the computational task of projecting the depth map onto the corresponding image plane and enhancing the accuracy of the data fusion.

In some implementations, the XR system can employ a centralized depth sensor. For example, a single sensor can be positioned at a central point on the frame, such as on the bridge of a pair of smart glasses, between the primary left and right cameras. The sensor can be oriented to capture depth information for the central area of the user's view. In some cases, this hardware-efficient approach can reduce component count and power consumption. In some implementations, the XR system can use a plurality of distributed depth sensors. For instance, a first depth sensor can be paired with a left-side camera, and a second depth sensor can be paired with a right-side camera, creating two distinct sensor modules. This configuration can provide robust depth information across a wide field of view. For example, in some cases, it can create redundant depth measurements, which can help to resolve occlusions and produce a high-fidelity 3D reconstruction, which can be advantageous for generating a Simultaneous Localization and Mapping (SLAM) model, as is described further herein.

Process 500 can obtain the depth data through any of one or more techniques, either individually or in combination. In some implementations, and as noted above, the depth data can be actively captured by one or more dedicated depth sensors integrated into the XR system. These sensors can include one or more of various types of technology suited for accurately measuring distances in an environment. For example, the XR system can employ a Time-of-Flight (ToF) sensor, which measures the time it takes for a pulse of infrared light to travel to an object and reflect back to the sensor. Alternatively or additionally, the XR system can use a structured light sensor, which projects a known pattern of light (e.g., dots or lines) onto the scene and analyzes the deformation of that pattern as it strikes surfaces at different distances. Alternatively or additionally, the XR system can use a LiDAR (Light Detection and Ranging) sensor, which can deploy laser pulses to rapidly scan the environment and generate a highly accurate point cloud representing the 3D structure of the scene. Process 500 can synchronize this captured depth data with the contemporaneous images obtained at block 502, ensuring that the geometric information aligns with the visual information across multiple points in time.

In other implementations, and/or to supplement the data from dedicated depth sensors, process 500 can computationally obtain and/or derive the depth data from the multiple images obtained at block 502 themselves. For example, by leveraging the spatially disparate locations of the multiple cameras, process 500 can apply photogrammetric techniques, such as structure from motion (SfM), to analyze the parallax effect (e.g., the apparent shift in the position of objects when viewed from different camera angles). Through processes such as triangulation, process 500 can then estimate the 3D position of features in the scene and generate a corresponding depth map without requiring a dedicated depth sensor, and/or in addition to the data collected by depth sensor(s), such as when depth data for a particular part of the scene is missing.

At block 506, process 500 can augment the multiple images with the obtained depth data. For example, process 500 can computationally fuse the two-dimensional (2D) visual information from the images with the 3D geometric information from the depth data. In some implementations, process 500 can augment the multiple images with the obtained depth data based on the known, fixed geometric relationship between the cameras and the one or more depth sensors on the XR system. This relationship, which in some cases can be established during a factory calibration and stored on the XR system, can provide the system with knowledge of the intrinsic parameters of each sensor (e.g., focal length, lens distortion, etc.) and the extrinsic parameters defining their relative positions and orientations (i.e., their poses) with respect to one another. In some implementations, using this calibration, process 500 can correlate the depth data with the corresponding pixels in the contemporaneously captured images.

For example, for each set of images captured at a specific moment in time, process 500 can use the synchronized depth data (e.g., a depth map and/or a point cloud) to assign a depth value to the pixels in each of one or more captured images. Thus, process 500 can produce a set of depth-augmented images (e.g., RGB-D images). In these augmented data structures, each pixel (and/or each set of pixels) can contain not only color and intensity information (e.g., RGB values), but also a corresponding depth value (a “Z” coordinate), effectively associating that pixel with a specific point in 3D space. Thus, process 500 does not merely have a 2D understanding of the scene, but rather a volumetric representation of the real-world environment as seen from multiple perspectives. Thus, process 500 can align and merge the different views in a geometric 3D space, rather than simply combining them as a flat panorama.

At block 508, process 500 can generate the 3D spatial video of the real-world environment by stitching together the multiple augmented images, thereby generating a volumetric and geometric representation of the real-world environment. In some implementations, process 500 can stitch the multiple augmented images together based on identified visual and/or depth features included in the augmented images. For example, process 500 can initially perform feature detection in which, for a given set of contemporaneously captured images, process 500 can execute one or more feature detection algorithms on each image (e.g., Scale-Invariant Feature Transform (SIFT), Speeded-Up Robust Features (SURF), Oriented FAST and Rotated BRIEF (ORB), and/or the like). The feature detection algorithm(s) can identify multiple unique, salient points (e.g., features) within the image that can act as distinct visual landmarks within the scene, such as corners, edges, and/or areas of high textural contrast. Once feature detection is performed, process 500 can perform feature matching. For example, process 500 can compare the descriptors of the features identified in one image against those in adjacent, overlapping images. Thus, process 500 can find pairs of corresponding points that represent the same physical point in the real-world environment as viewed from two or more different camera perspectives.

Once more than a threshold number of correspondences are established, process 500 can perform pose estimation. For example, process 500 can leverage the fact that the images have been augmented with depth data (i.e., are RGB-D images). Because one or more matched feature point has a known 3D coordinate (X, Y, Z) from its respective camera's viewpoint, process 500 can use a known algorithm, such as the Iterative Closest Point (ICP) algorithm (or a similar method), that can iteratively calculate the optimal rigid transformation (i.e., the rotation and translation) that minimizes the distance between the corresponding sets of 3D points, thereby determining the relative pose between the cameras.

With the relative poses of all cameras determined for that specific frame, process 500 can then perform the stitching. For example, process 500 can project (e.g., warp) all the depth-augmented images into a single, common 3D coordinate system. In the overlapping regions, the pixel and depth data from the different views can be blended together to create a final, seamless, and geometrically consistent spatial video frame. The feature detection, feature matching, pose estimation, and stitching processes can then be repeated independently for each successive set of contemporaneous images, generating the final, continuous 3D spatial video frame by frame.

Alternatively or additionally, in some implementations, process 500 can generate a localization model (e.g., a Simultaneously Localization and Mapping (SLAM) model) of the real-world environment based on the multiple captured images and the depth data in order to stitch together the multiple augmented images. For example, process 500 can analyze the visual data from the multiple cameras to identify and track salient feature points (e.g., corners, edges, textures, etc.) across successive frames and from different viewpoints. This visual information can provide a continuous estimate of the XR system's motion. Simultaneously, the depth data captured by the one or more depth sensors can provide direct, metric-scale information about the 3D structure of the environment, creating a point cloud of the scene.

The localization model can fuse these data sources (e.g., the visual features from the images and the geometric structure from the depth data) to build and refine a map of the surrounding real-world environment, while tracking the six-degree-of-freedom (6DoF) pose (i.e., the X, Y, Z position and roll, pitch, yaw orientation) of the XR system within that map. Once the localization model has determined the pose of the overall XR system at a given moment, process 500 can then determine the relative poses of the multiple cameras. Because the cameras are mounted at fixed, known positions and orientations on the XR system's frame (e.g., a relationship established during factory calibration), their individual poses within the global coordinate system of the SLAM map can be precisely calculated. Thus, process 500 can determine, for any of multiple points in time, where each camera was located and in which direction it was pointing relative to other camera(s) and to the real-world environment itself.

In some implementations, process 500 can utilize the relative poses (e.g., position and orientation) of the multiple cameras, which were determined from the localization model (e.g., a SLAM model), to accurately place and orient each set of depth-augmented image data within a single, unified 3D coordinate system. In some implementations, from this unified point cloud, process 500 can generate a 3D mesh, comprising, e.g., a network of polygons (e.g., triangles), to represent the continuous surfaces of objects in the real-world environment. Process 500 can then project the color and texture information from the original images onto this 3D mesh, effectively painting the geometric structure with a realistic visual appearance. In some implementations where multiple cameras have captured the same surface, process 500 can blend the textures from the different viewpoints to generate a seamless and photorealistic result. This reconstruction process can be performed iteratively for each set of contemporaneously captured images over time. By sequencing the resulting 3D reconstructed frames, process 500 can create a continuous, moving 3D spatial video that captures the dynamics of the original scene, such as the movement of people or objects.

In some implementations, process 500 can further adjust a viewpoint of the generated 3D spatial video based on a determined distance between one or more eyes of a user, of the XR system, and the multiple cameras. In some cases, process 500 can perform this step to correct for the inherent offset between the physical location of the cameras on the XR system frame and the actual position of the user's pupils, thereby creating a final spatial video that more accurately represents the user's true first-person perspective. For example, process 500 can initially determine the position of the user's eyes relative to the XR system. This can be accomplished in one or more of several ways. In some implementations, process 500 can use pre-set, assumed values for a standard interpupillary distance (IPD) and eye position relative to the frame. In some implementations, the user can perform a one-time calibration routine where the XR system measures their specific eye position. In some implementations, the XR system can be equipped with inward-facing eye-tracking sensors (e.g., infrared cameras) that can continuously track the real-time position of the user's pupils. Concurrently, the XR system has knowledge of the fixed position and orientation of each of the multiple cameras on its frame from its factory calibration. By combining the determined eye position data with the known camera position data, process 500 can calculate the 3D vector offset between where the cameras are and where the user's eyes are.

Process 500 can then adjust the viewpoint through view synthesis or re-projection. Instead of using the captured views directly, process 500 can utilize the fully stitched, 3D model of the environment (e.g., the fused point cloud or 3D mesh) as a virtual set. Process 500 can then computationally place a virtual camera at the 3D coordinate corresponding to the user's actual eye position, and render a new image of the 3D model from the perspective of this virtual camera. In some implementations, process 500 can perform these steps for both the left and right eyes, creating a new, synthesized stereoscopic image pair that represents what the user would have seen from their natural viewpoint. In some implementations, by performing this viewpoint adjustment, process 500 can mitigate an unnatural apparent forehead or cheek viewpoint that can occur when viewing video captured from a camera that is not aligned with the user's eyes. This can lead to a more comfortable, natural, and immersive viewing experience for a person replaying the captured moment.

In some implementations, process 500 can further synchronize the generated video stream with any captured and/or generated audio data (e.g., mono, stereo, or spatial audio) that was captured by the XR system's microphones. In such implementations, the final output can be a cohesive, immersive, and geometrically accurate 3D audio-visual representation of the real-world environment, suitable for storage. In some implementations, process 500 can further transmit the generated 3D spatial video to an XR playback system, either directly (e.g., using local wireless and/or wired communication techniques), and/or indirectly (e.g., through a remote computing system). In some implementations, transmitting the generated 3D spatial video can include streaming the generated 3D spatial video in real-time or near real-time as the 3D spatial video is generated (e.g., within 1 second). In some implementations, process 500 can further locally and/or remotely store the 3D spatial video for later reply on the same or a separate XR system.

FIG. 6 is a conceptual diagram illustrating an example augmented reality (AR) system 600 in the form of smart glasses, which, in some cases, can include at least some of the same components of the HMDs described herein with respect to FIGS. 2A and 2B. In various implementations, smart glasses may or may not include display components that provide visual output to a user. AR system 600 can include a rigid body 602 (e.g., a frame) and lenses 604, which can be at least partially see-through. AR system 600 can further include cameras 606A-606H which, in some implementations, can further include depth sensors (not shown). Cameras 606A-606H can be configured to capture contemporaneous and successive images (which, in some cases, can include video) and/or depth data of the real-world environment surrounding a user of AR system 600 from multiple positions and/or orientations. In some implementations, AR system 600, via internal processing components (not shown), can further be configured to process such images and depth data, stitching it together to generate a three-dimensional (3D) spatial video, as described further herein. In other implementations, AR system 600 can be in operable communication with external processing components and/or computing systems providing the post-processing functionality. In some implementations, through communication components, AR system 600 can provide the 3D spatial video to other XR systems (e.g., XR playback systems), either directly or indirectly over a network (such as described further herein), which can playback the 3D spatial video, and in some cases, in real-time or near real-time (e.g., within 1 second of the images being captured).

FIGS. 7A-7B are conceptual diagrams illustrating an example of an XR system 702 capturing multiple images of a real-world environment and merging them to form a 3D spatial video. For example, view 700A of FIG. 7A illustrates the capture phase of the process. XR system 702 can utilize a plurality of cameras disposed at spatially disparate locations to capture a wide field of view of a real-world environment. In this example, XR system 702 captures a series of multiple, contemporaneous images 704-712. Each of these images captures a different but overlapping portion of the surrounding environment, which contains various features such as circle 714, square 716, triangle 718, circle 720, square 722, triangle 724, square 726, and rectangle 728. In conjunction with capturing images 704-712, one or more depth sensors on XR system 702 can capture depth data corresponding to the scene, providing dimensional information for features 714-728. In some implementations, if dedicated depth sensors are not available, this depth data can be computationally derived or interpolated from the multiple perspectives provided by images 704-712 themselves, as described further herein. In some implementations, one or more microphones on XR system 702 can capture ambient audio data, which may include mono, stereo, or spatial audio, to be synchronized with the generated spatial video.

Referring now to FIG. 7B, view 700B illustrates the processing and generation phase. Individual images 704-712 captured in the first phase serve as input to a stitching or merging process. XR system 702 can process these images to generate a cohesive 3D spatial video, such as by identifying and matching common features that are present in the overlapping portions of adjacent images. For example, as indicated by arrow 752, a portion of square 716A in image 704 can be matched with the corresponding partial feature 716B in image 706. Similarly, at arrow 754, triangle 718A in image 706 can be matched with the partial feature 718B in image 708. This matching process can continue across the image set, as shown at arrow 756 where feature 722A is matched with partial feature 722B, and at arrow 758 where feature 726A is matched with partial feature 726B.

This feature matching, combined with the captured or derived depth data, can be used to build a comprehensive 3D understanding of the scene. For example, in some implementations, a localization model, such as a Simultaneous Localization and Mapping (SLAM) model, can be generated based on the image and depth data. This model can be used to determine the precise relative position and orientation (e.g., pose) of each camera at the moment of capture. As indicated by arrow 760, based on these determined poses and matched features, the system can stitch the multiple augmented images together. This stitching is not a simple 2D panoramic combination; rather, it is a 3D reconstruction that aligns the images in a virtual space. The result is a single, cohesive spatial video frame 762 that includes all the features 714-728 from the original captured images in a unified 3D representation. This process can be repeated for successive sets of contemporaneous images to create the final, moving 3D spatial video.

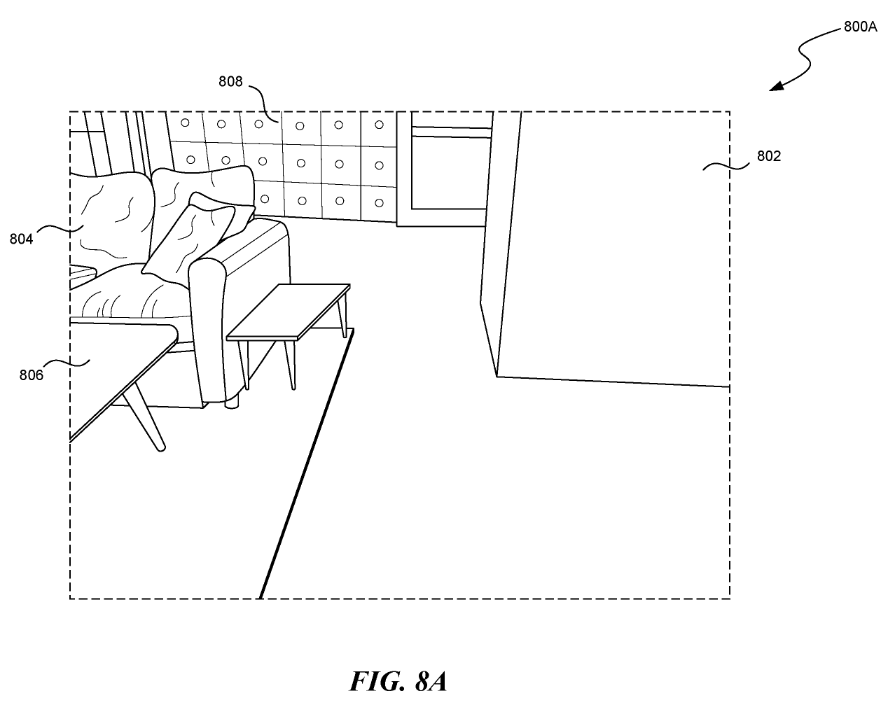

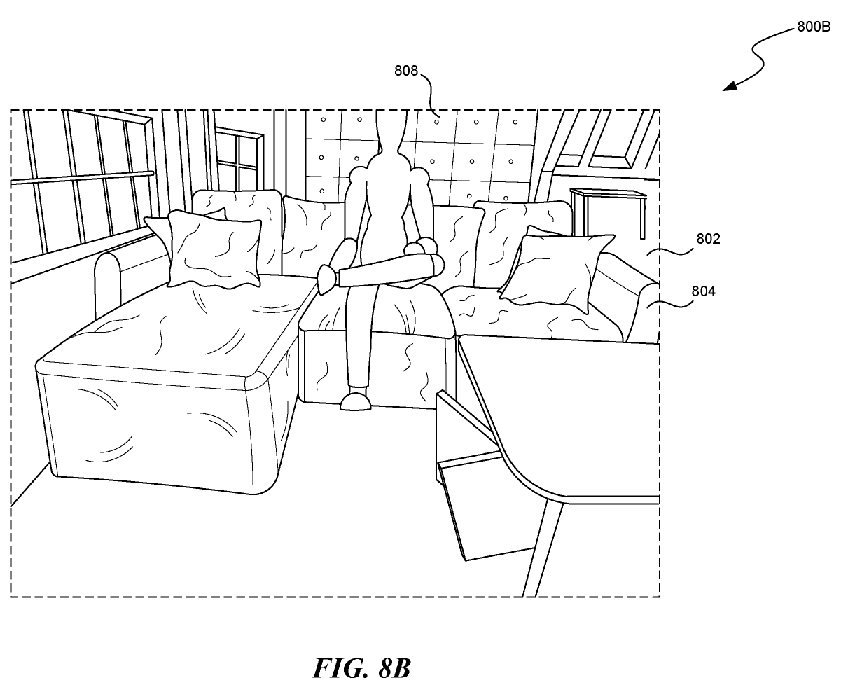

FIGS. 8A-8B are conceptual diagrams illustrating example views 800A-800B of a 3D spatial video, generated via images and/or depth data captured by an XR system (e.g., an AR system), and played back on an XR playback system (e.g., a VR system). For example, to capture the data necessary to generate the 3D spatial video, a user wearing an XR system, such as a pair of lightweight and unintrusive AR smart glasses, casually walks through a real-world environment; in this case, living room 802. As the user walks, the XR system's multiple cameras and depth sensors continuously capture contemporaneous images and corresponding depth data of the scene from the user's changing first-person perspective. This multi-modal data is then processed, either on-device or by a connected computing system, to generate a cohesive 3D spatial video that represents the user's complete walkthrough of the environment.

The resulting 3D spatial video is then provided to an XR playback system, such as a VR head-mounted display (HMD), for immersive viewing. Referring to FIG. 8A, view 800A represents a first moment or "screenshot" from the playback of this captured walkthrough. The viewpoint is from near the entrance of living room 802, showing the environment from that perspective. A playback user wearing the VR headset perceives the scene, including couch 804, coffee table 806, and shelving unit 808, not as a flat image, but with a true sense of depth, scale, and spatial presence in three-dimensions.

Referring to FIG. 8B, view 800B represents a subsequent moment in the playback of the same 3D spatial video. As the playback of the captured walkthrough progresses, the viewpoint has moved forward into living room 802, now showing the scene from a position closer to couch 804. The seamless generation of the 3D spatial video, as conceptually illustrated by the transition from the viewpoint in view 800A to the viewpoint in view 800B, can be accomplished by stitching together the multiple captured images based on the visual features within the scene. In some implementations, this process involves identifying and tracking stable, salient points in living room 802 to create a geometrically accurate 3D reconstruction. For example, for any given moment in time during the user's walkthrough, the XR system's multiple cameras can capture a set of contemporaneous images. Within each of these images, the XR system can identify multiple unique visual features (e.g., hundreds or thousands). While in some cases these can be entire objects, in others they can be specific, algorithmically recognizable points within them. For example, within the scene shown in views 800A and 800B, such features could include the distinct corner of an armrest on couch 804, a specific pattern on a cushion, the sharp edge of coffee table 806, the intersection of two shelves on shelving unit 808, etc. Together, FIGS. 8A and 8B illustrate how the system transforms a casually recorded moment into a dynamic, replayable, and immersive 3D video.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., "non-transitory" media) and computer-readable transmission media.

Reference in this specification to "implementations" (e.g., "some implementations," "various implementations," “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase "selecting a fast connection" can be understood to mean selecting a connection that has a value assigned corresponding to its connection speed that is above a threshold.

As used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for generating three-dimensional spatial video for an extended reality playback system, the method comprising:
obtaining multiple images of a real-world environment, wherein the multiple images were contemporaneously captured from multiple perspectives by multiple cameras disposed at spatially disparate locations on an extended reality system;
obtaining depth data corresponding to the real-world environment, wherein the depth data was captured by one or more depth sensors on the extended reality system;
augmenting the multiple images with the obtained depth data; and
generating the three-dimensional spatial video of the real-world environment by stitching together the multiple augmented images,
wherein the extended reality playback system renders the three-dimensional spatial video.

2. The method of claim 1, wherein the extended reality system is an augmented reality or mixed reality system.

3. The method of claim 1, wherein the extended reality system is an augmented reality system embodied as smart glasses comprising a pair of see-through lenses.

4. The method of claim 1, further comprising:
transmitting the generated three-dimensional spatial video to the extended reality playback system.

5. The method of claim 4, wherein the one or more extended reality playback systems includes one or more virtual reality systems, one or more mixed reality systems, or any combination thereof.

6. The method of claim 4, wherein the transmitting the generated three-dimensional spatial video includes streaming the generated three-dimensional spatial video in real-time or near real-time as the three-dimensional spatial video is generated.

7. The method of claim 1, further comprising:
obtaining one or more additional images of the real-world environment from one or more cameras external to the extended reality system; and
incorporating the one or more additional images into the generated three-dimensional spatial video.

8. The method of claim 7, wherein the one or more cameras are integral with one or more wearable accessories in networked communication with the extended reality system.

9. The method of claim 1, wherein the stitching together the multiple augmented images includes matching common features identified in overlapping portions of the multiple augmented images.

10. The method of claim 1, further comprising:
generating a localization model of the real-world environment based on the multiple obtained images and the obtained depth data; and
determining relative poses of the multiple cameras based on the generated localization model,
wherein the stitching together the multiple augmented images is based on the determined relative poses of the multiple cameras.

11. The method of claim 1, further comprising:
adjusting a viewpoint of the generated three-dimensional spatial video based on a determined distance between one or more eyes of a user, of the extended reality system, and the multiple cameras.

12. A computer-readable storage medium storing instructions, for generating three-dimensional spatial video for an extended reality playback system, the instructions, when executed by a computing system, cause the computing system to:
obtain multiple images of a real-world environment, wherein the multiple images were contemporaneously captured from multiple perspectives by multiple cameras disposed at spatially disparate locations on an extended reality system;
obtain depth data corresponding to the real-world environment, wherein the depth data was captured by one or more depth sensors on the extended reality system;
augment the multiple images with the obtained depth data; and
generate the three-dimensional spatial video of the real-world environment by stitching together the multiple augmented images,
wherein the extended reality playback system renders the three-dimensional spatial video.

13. The computer-readable storage medium of claim 12, wherein the extended reality system is an augmented reality system embodied as smart glasses comprising a pair of see-through lenses.

14. The computer-readable storage medium of claim 12, wherein the instructions, when executed by the computing system, further cause the computing system to:
transmit the generated three-dimensional spatial video to the extended reality playback system.

15. The computer-readable storage medium of claim 14, wherein the extended reality playback system includes one or more virtual reality systems, one or more mixed reality systems, or any combination thereof.

16. The computer-readable storage medium of claim 14, wherein the transmitting the generated three-dimensional spatial video includes streaming the generated three-dimensional spatial video in real-time or near real-time as the three-dimensional spatial video is generated.

17. A computing system for generating three-dimensional spatial video for an extended reality playback system, the computing system comprising:
one or more processors; and
one or more memories storing instructions that, when executed by the one or more processors, cause the computing system to:
obtain multiple images of a real-world environment, wherein the multiple images were contemporaneously captured from multiple perspectives by multiple cameras disposed at spatially disparate locations on an extended reality system;
obtain depth data corresponding to the real-world environment, wherein the depth data was captured by one or more depth sensors on the extended reality system;
augment the multiple images with the obtained depth data; and
generate the three-dimensional spatial video of the real-world environment by stitching together the multiple augmented images,
wherein the extended reality playback system renders the three-dimensional spatial video.

18. The computing system of claim 17, wherein the instructions, when executed by the one or more processors, further cause the computing system to:
obtain one or more additional images of the real-world environment from one or more cameras integral with one or more wearable accessories in networked communication with the extended reality system; and
incorporate the one or more additional images into the generated three-dimensional spatial video.

19. The computing system of claim 17, wherein the instructions, when executed by the one or more processors, further cause the computing system to:
generating a localization model of the real-world environment based on the multiple obtained images and the obtained depth data; and
determining relative poses of the multiple cameras based on the generated localization model,
wherein the stitching together the multiple augmented images is based on the determined relative poses of the multiple cameras.

20. The computing system of claim 17, wherein the instructions, when executed by the one or more processors, further cause the computing system to:
adjusting a viewpoint of the generated three-dimensional spatial video based on a determined distance between one or more eyes of a user, of the extended reality system, and the multiple cameras.
